(19) United States
(12) Patent Application Publication
(10) Pub. No.: US 2026/0078668 A1
(43) Pub. Date: Mar. 19, 2026

(54) CLASSIFICATION OF MATERIALS IN AN ANNULUS OF A WELLBORE

(71) Applicant: HALLIBURTON ENERGY SERVICES, INC., Houston, TX (US)

(72) Inventors: Yingyu Qi, Singapore (SG); Amit Padhi, Houston, TX (US); Jichun Sun, Singapore (SG); Qingtao Sun, Houston, TX (US); Ruijia Wang, Singapore (SG)

(73) Assignee: HALLIBURTON ENERGY SERVICES, INC., Houston, TX (US)

(21) Appl. No.: 18/884,882

(22) Filed: Sep. 13, 2024

(51) Int. Cl. E21B 47/005; E21B 47/13; G01V 1/50

(52) U.S. Cl. CPC E21B 47/005; E21B 47/13; G01V 1/50

(57) ABSTRACT

Disclosed are systems, apparatuses, methods, and computer readable medium for determining a phase of a material in an annulus between a barrier and a formation of a well. The present disclosure includes deploying a tool having a plurality of receivers and a transmitter; emitting first visco-elastic waves; recording first waveform data received; calculating the attenuation of A₀ visco-elastic waves; rotating the transmitter to a second incidence angle that is different from the first incidence angle; retracting the tool from the predetermined depth; emitting, as the tool is retracted from the predetermined depth, from the transmitter, at the second incidence angle, second visco-elastic waves; recording second waveform data received at at least two of the plurality of receivers resulting from the second visco-elastic waves; calculating the attenuation of S₀ visco-elastic waves; determining if a phase of material in the annulus is gas, liquid or solid.

### TECHNICAL FIELD

The present technology pertains to determining a phase of a material in an annulus between a barrier and a formation of a well.

### BACKGROUND

A well system comprises a well-drilling system to form the well and a well-pumping system to retrieve materials from the well. A well-drilling system is a setup of equipment and machinery designed to extract natural resources, such as water, oil, or gas, from the ground. The system typically includes a drilling rig, which is used to bore a hole into the earth's crust, a casing, which can be a steel pipe that lines the well and cementation between casing and the wall of well which prevents the walls from collapsing. The drilling process begins with the placement of a drill bit at the end of a drill string. The drill bit is then rotated, using a motor or a manual mechanism, to create a hole in the ground. As the hole is drilled, the drill string is gradually lengthened by adding more sections of pipe and cementation outside the pipe. The process continues until the desired depth is reached.

Once the drilling is complete, a casing is installed into the well to protect it from collapse and prevent contamination of the extracted resources. The casing is typically cemented into place to seal off any potential pathways for groundwater to enter the well. Once the well is prepared, a well-pumping system is installed to extract the resources from the well.

### BRIEF DESCRIPTION OF THE DRAWINGS

In order to describe the manner in which the various advantages and features of the disclosure may be obtained, a more particular description of the principles described herein will be rendered by reference to specific embodiments thereof which are illustrated in the appended drawings. Understanding that these drawings depict only example embodiments of the disclosure and are not to be considered to limit its scope, the principles herein are described and explained with additional specificity and detail through the use of the drawings in which:

FIG. 1 is a schematic diagram of an example logging while drilling (LWD) wellbore operating environment in accordance with various aspects of the disclosure;

FIG. 2 is a diagram of an example downhole environment having tubulars, in accordance with various aspects of the disclosure;

FIG. 3 is a close up view of a tool having a plurality of receivers and an adjustable transmitter within a barrier of a well;

FIG. 4 illustrates an example method in accordance with various aspects of the disclosure;

FIG. 5 illustrates a graph of a plot of data in accordance with various aspects of the disclosure;

FIG. 6 illustrates an example of creating the cross plot for features of symmetric and antisymmetric lamb waves.

FIG. 7 illustrates an example of a system in accordance with various aspects of the disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and descriptions are not intended to be restrictive.

The ensuing description provides example aspects only and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

The present disclosure includes a method, system, and apparatus for determining a phase of a material in an annulus between a barrier and a formation of a well. A barrier separates phases of the same or different materials in a wellbore, exemplified but not limited to tubing inside a barrier, barrier is a single cased wellbore and barriers in a multi-cased wellbore. The present disclosure includes deploying a tool having a plurality of receivers and a source or transmitter, which can be rotated to form a first incidence angle with the casing, into the barrier in a first direction. The present disclosure also includes emitting, as the tool is deployed to a predetermined depth, from the source or transmitter, at the first incidence angle, first visco-elastic waves to insonify the barrier locally. Insonifying the barrier with mechanical waves from the source or transmitter generates waves within the barrier that travel along the body of the barrier. Furthermore, the present disclosure includes recording first waveform data received at each of the plurality of receivers resulting from the first visco-clastic waves. A mechanical wave propagating in visco-clastic materials is referred to as visco-elastic wave. In at least one example, the visco-elastic wave includes an acoustic pressure pulse, which can propagate when the medium has zero shear velocity. The present disclosure can also include rotating, at the predetermined depth, the source or transmitter to a second incidence angle that is different from the first incidence angle. Once the tool is at the predetermined depth, the present disclosure includes retracting the tool from the predetermined depth. While the tool is being retracted from the predetermined depth, the present disclosure includes emitting from the source or transmitter, at the second incidence angle, second visco-elastic waves. In at least one example, the second lamb waves can be the same as the first visco-elastic waves. In another example, the second visco-elastic waves can be different from the first visco-clastic waves. The present disclosure also records second waveform data received at each of the plurality of receivers resulting from the second visco-elastic waves. The present disclosure in at least one example generates a data plot, of the first recorded waveform data and second recorded waveform data, with a vertical axis of symmetric zero-order mode (S₀) attenuation and a horizontal axis of zero-order antisymmetric mode (A₀) attenuation. The present disclosure can then determine the material of cementing phase associated with the data. In at least one example, the determination of a material phase can include determining if the material in an annulus is gas, liquid or solid.

Additional details and aspects of the present disclosure are described in more detail below with respect to the figures.

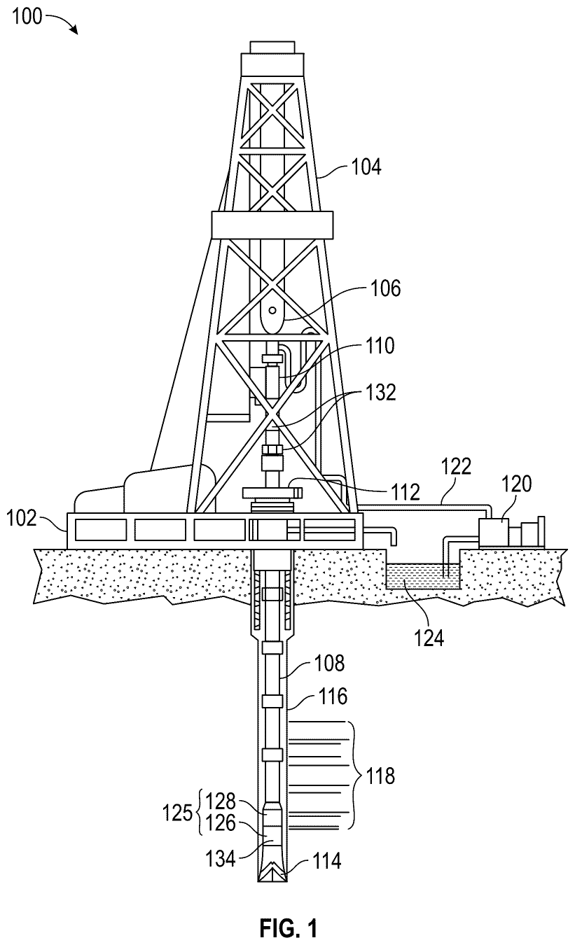

FIG. 1 is a schematic diagram of an example logging while drilling (LWD) operating environment of a well site, in accordance with various aspects of the disclosure.

In some aspects, a drilling arrangement is shown that exemplifies a LWD configuration in a wellbore drilling scenario 100. The LWD typically incorporates sensors that acquire formation data. The drilling arrangement of FIG. 1 also exemplifies measurement while drilling (MWD) and utilizes sensors to acquire data from which the wellbore's path and position in three-dimensional space may be determined. FIG. 1 shows a drilling platform 102 equipped with a derrick 104 that supports a hoist 106 for raising and lowering a drill string 108. The hoist 106 suspends a top drive 110 suitable for rotating and lowering the drill string 108 through a well head 112. A drill bit 114 may be connected to the lower end of the drill string 108. As the drill bit 114 rotates, the drill bit 114 creates a wellbore 116 that passes through one or more subterranean formations 118. A pump 120 circulates drilling fluid through a supply pipe 122 to top drive 110, down through the interior of the drill string 108, and out orifices in the drill bit 114 into the wellbore. The drilling fluid returns to the surface via the annulus around the drill string 108, and into a retention pit 124. The drilling fluid transports cuttings from the wellbore 116 into the retention pit 124 and the drilling fluid's presence in the annulus aids in maintaining the integrity of the wellbore 116. Various materials may be used for drilling fluid, including oil-based fluids and water-based fluids.

While drilling, the well is cemented to prevent collapse and fluid flowing outside of the casing. In some instances, some space remains for liquid and gas during cementing resulting in the potential leakage during production or even collapse of well wall. The present disclosure allows for classification of the materials in the cementing layer (also called annulus in the disclosure) into solid (for example, cement), liquid, and/or gas. The present disclosure also provides for detecting the potential risk for wall of the well after cementing.

In some aspects, one or more logging tools 126 may be integrated into the bottom-hole assembly 125 near the drill bit 114. As the drill bit 114 extends the wellbore 116 through the subterranean formations 118, logging tools 126 collect measurements relating to various formation properties as well as the orientation of the tool and various other drilling conditions. In some cases, the logging tools interface with various sensors and equipment. The bottom-hole assembly 125 may also include a telemetry sub 128 to transfer measurement data to a surface receiver 132 and to receive commands from the surface. In at least some cases, the telemetry sub 128 communicates with a surface receiver 132 using mud pulse telemetry. In some instances, the telemetry sub 128 does not communicate with the surface, but rather stores logging data for later retrieval at the surface when the logging assembly is recovered.

Each of the logging tools 126 may include one or more tool components spaced apart from each other and communicatively coupled by one or more wires and/or another communication arrangement. The logging tools 126 may also include one or more computing devices communicatively coupled with one or more of the tool components. The one or more computing devices may be configured to control or monitor the performance of the tool, process logging data, and/or carry out one or more aspects of the methods and processes of the present disclosure.

In at least some instances, one or more of the logging tools 126 may communicate with a surface receiver 132 by a wire, such as a wired drill pipe. In other cases, the one or more of the logging tools 126 may communicate with a surface receiver 132 by wireless signal transmission, such as ground penetrating radar. In at least some cases, one or more of the logging tools 126 may receive electrical power from a wire that extends to the surface, including wires extending through a wired drill pipe.

In some aspects, a collar 134 is a frequent component of a drill string 108 and generally resembles a very thick-walled cylindrical pipe, typically with threaded ends and a hollow core for the conveyance of drilling fluid. In some cases, multiple collars 134 may be included in the drill string 108 and are constructed and intended to be heavy to apply weight on the drill bit 114 to assist the drilling process. Because of the thickness of the collar's wall, pocket-type cutouts or other type recesses may be provided into the collar's wall without negatively impacting the integrity (strength, rigidity, and the like) of the collar 134 as a component of the drill string 108.

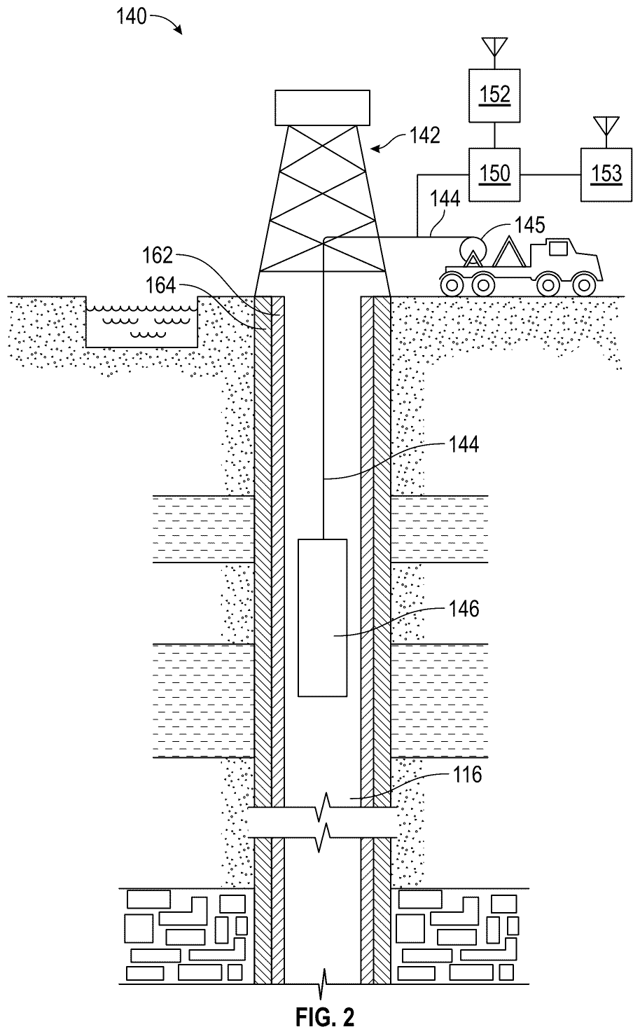

FIG. 2 is a diagram of an example downhole environment having tubulars in accordance with various aspects of the disclosure. In some aspects, an example system 140 is depicted for conducting downhole measurements after at least a portion of a wellbore has been drilled and the drill string removed from the well. A downhole tool is shown having a tool 146 to perform logging, measurements, and/or other operations. For example, instead of using the drill string 108 of FIG. 1 to lower a tool 146, which may contain sensors and/or other instrumentation for detecting and logging nearby characteristics and conditions of the wellbore 116 and surrounding formations, a wireline conveyance 144 may be used.

The tool 146 may be lowered into the wellbore 116 by wireline conveyance 144. The wireline conveyance 144 may be anchored in the drill rig 142 or by a portable device such as a truck 145. The wireline conveyance 144 may include one or more wires, slicklines, cables, and/or the like, as well as tubular conveyances such as coiled tubing, joint tubing, or other tubulars.

The wireline conveyance 144 provides power and support for the tool, as well as enabling communication between processing systems 150 on the surface. In some examples, the wireline conveyance 144 may include electrical and/or fiber optic cabling for performing any communications. The wireline conveyance 144 is sufficiently strong and flexible to tether the tool 146 through the wellbore 116, while also permitting communication through the wireline conveyance 144 to one or more of the processing systems 150, which may include local and/or remote processors. Additionally, the processing systems 150 can be coupled to a first communication system 152 that can communicate via wireless and/or satellite connections. Additionally, a local communication device 153 can be included. The local communication device 153 can communicate with other devices near the site. In some cases, power may be supplied via the wireline conveyance 144 to meet the power requirements of the tool. For slickline or coiled tubing configurations, power may be supplied downhole with a battery or via a downhole generator.

As illustrated, the tool can be located within a casing 162 that can be coupled to the formation by cement 164 that is located within an annulus formed between the casing 162 and the formation.

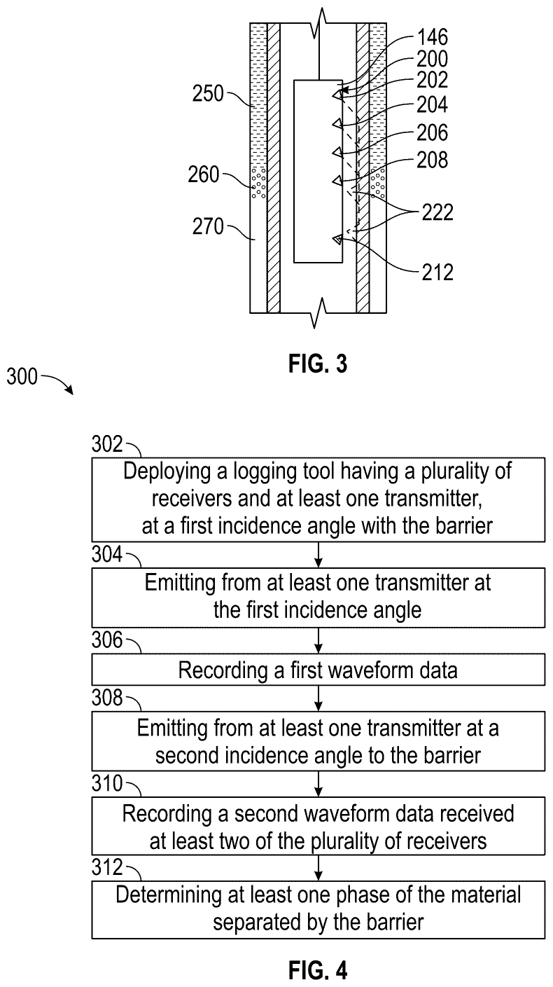

FIG. 3 illustrates an example of a tool 146 having plurality of receivers 200 and an adjustable source or transmitter 212. The plurality of receivers 200 can include a first receiver 208, a second receiver 206, a third receiver 204, and a fourth receiver 202. The angle of incidence 222 of the transmitter 212 and receiver 200 is illustrated. As illustrated, the angle of incidence of the receivers 200 is negative angle of the incidence angle of transmitter 212. The transmitter 212 and receivers 200 can include an adjustment mechanism whereby the angle of incidence can be adjusted. As described herein, the angle of incidence can be such that a first incidence angle is formed for the transmitter 212 as the tool 146 is lowered to a predetermined depth. The transmitter 212 can be rotated such that a second incidence angle is formed for the transmitter 212 as the tool is retracted or raised from the predetermined depth. The predetermined depth can be the deepest point of interest or some distance beyond the depth of interest.

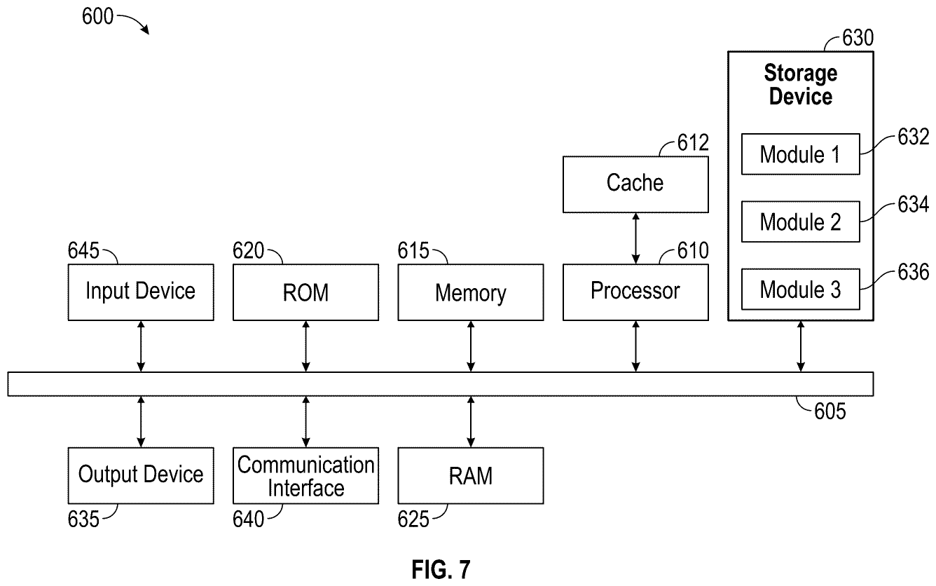

The tool 146 is operable to provide data that can be used to determine the phase of material in the cementing layer as mentioned above. In order to further illustrate the material in the annulus, the illustration provides a liquid material 250, a gaseous material 260, and a solid material 270. While the materials are shown distinctly, the materials can be mixed among each other. The data from the tool 146 can be sent to one of the processing systems 150. Further operating components of the processing systems 150 are illustrated in FIG. 7 and described below.

FIG. 4 illustrates an example method for determining a phase of a material in an annulus between a barrier and/or casing 162 and a formation of a well in accordance with some aspects of the disclosure. Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

In some aspects, the method 300 may be executed by a computing system 150 that is operably coupled to the tool 146.

At block 302, the method may deploy a logging tool having a plurality of receivers and at least one transmitter, at a first incidence angle with the barrier, to insonify at least a part of the barrier with at least one transmitter. In at least one example, the barrier comprises at least one of tubing, barrier in a single cased wellbore, and/or at least one barrier in a multi-cased wellbore. In at least one example, the first incidence angle is larger than thirty degrees. The method can adjust the first incidence angle based upon a fluid within the barrier, barrier material, and/or barrier thickness. In at least one example, the first incidence angle of transmitter may be a negative angle of a first incidence angle of the receivers. In at least one example, the first incidence angle of transmitter may be about a negative angle of a first incidence angle of the receivers, such that the deviation can be up to about five degrees.

Table 1 shows examples for the chose of first incidence angle for different drilling fluid and barrier. For example, the barrier thickness can be used to calculate the incidence angle. In at least one example, the method can adjust the first incidence angle as a thickness of the barrier changes. Additionally, the incidence angle can further be calculated in dependence upon whether there is a fluid located within the barrier such that the tool pass through a fluid as it proceeds down hole. The method can adjust the first incidence angle as a fluid within the barrier changes.

| Drilling Fluid | Drilling | Barrier | | Incidence |
|---|---|---|---|---|
| P velocity | Fluid Density | Thickness | Frequency | angle |
| V_{P} (m/s) | ρ(kg/m³) | (inch) | (kHz) | (degree°) |
| 1604 | 1550 | 0.4 | 220 | 34 |
| 1604 | 1550 | 0.6 | 180 | 33 |
| 1219 | 1100 | 0.4 | 220 | 27 |

The method may include adjusting the first incidence angle based upon a fluid within the barrier, barrier material, and barrier thickness. In at least one example, the method can include adjusting the first incidence angle provides that A₀ lamb wave travels in parallel to the barrier. The method can also include adjusting the first incidence angle as a diameter of the barrier changes.

As illustrated above, the plurality of receivers can number four or more. The number of receivers allows for enhanced sensitivity and/or reduction in calculation error.

At block 304, the method may emit from at least one transmitter, at the first incidence angle, from at least one transmitter, at the first incidence angle, a first visco-elastic wave, wherein the barrier is operable to guide in part the first visco-elastic wave. In at least one example, the first visco-elastic waves can be lamb waves. In at least one example, a mode of the first visco-elastic wave can be a combination of zero (S₀), first (S₁), and/or higher (Sₙ) order symmetric lamb wave.

At block 306, the method may a first waveform data received at least two of the plurality of receivers. In at least one example, the first waveform data includes data at least in part from the barrier. The method can use Hillbert transform to find the envelop of A0 wave and calculate the attenuation using the following equation:

$$attenuation = \frac{60}{d z} \frac{2 {\sum }_{i = 1}^{n} i log ( {Amp}_{i} ) - ( n + 1 ) {\sum }_{i = 1}^{n} log ( {Amp}_{i} )}{n ( 2 n + 1 ) ( n + 1 )} .$$

Here, Ampᵢ is the peak of the A0 envelop's amplitude, dz is the distance between adjacent receivers, and n is the total number of receivers.

At block 308, the method may emit, from at least one transmitter at a second incidence angle to the barrier, a second visco-elastic wave. In at least one example, the barrier is operable to guide in part the second visco-elastic wave. Table 2 shows examples for the chose of second incidence angle for different drilling fluid and barrier. In at least one example, the second incidence angle is less than twenty degrees.

| Drilling Fluid | Drilling | Barrier | | Incidence |
|---|---|---|---|---|
| P velocity | Fluid Density | Thickness | Frequency | angle |
| V_{P} (m/s) | ρ(kg/m³) | (inch) | (kHz) | (degree°) |
| 1604 | 1550 | 0.4 | 220 | 21 |
| 1604 | 1550 | 0.6 | 180 | 27 |
| 1219 | 1100 | 0.4 | 220 | 16 |

In at least one example, the method includes adjusting the second incidence angle as a thickness of the barrier changes. The method can also adjust the second incidence angle as the drilling fluid changes. The method can also include adjusting the second incidence angle as a diameter of the barrier changes. In at least one example, the second incidence angle of transmitter is a negative angle of a second incidence angle of the receivers. In at least one example, the second incidence angle of transmitter is a about negative angle of a second incidence angle of the receivers, such that the deviation can be up to about five degrees.

In at least one example, the method may include adjusting the second incidence angle based upon a fluid within the barrier, barrier material, and barrier thickness. In at least one example, the method can include adjusting the second incidence angle provides that S₀ lamb wave travels in parallel to the barrier. In at least one example, a mode of the first or second visco-elastic waves can be a combination of zero (A₀), first (A₁) or higher (Aₙ) order antisymmetric lamb waves. In at least one example, the features of the first and second visco-elastic waves can be attenuations of the waves. In other examples, the features can be one or more attributes of the waves including but not limited to amplitudes, frequencies, wavelengths, wave types, energy, wave speeds, and/or attenuations.

At block 310, the method may record a second waveform data received at least two of the plurality of receivers. In at least one example, the second waveform data includes data at least in part from the barrier.

At block 312, the method may determine at least one phase of the material separated by the barrier at least in part by features of the first recorded waveform data and the second recorded waveform data. In at least one example, the second vibrational waves can be lamb waves. Table 3, record 1 and 2 illustrates that in at least one example, the first visco-elastic waves and the second visco-elastic waves can have a same frequency. Table 3, record 1 and 3 illustrates that in at least one example, the first visco-elastic waves and the second visco-elastic waves can have a different frequency.

| | Drilling | Drilling | | | |
|---|---|---|---|---|---|
| | Fluid | Fluid | Barrier | | Incidence |
| | P velocity | Density ρ | Thickness | Frequency | angle |
| | V_{P} (m/s) | (kg/m³) | (inch) | (kHz) | (degree °) |
| First | 1604 | 1550 | 0.4 | 220 | 34 |
| lamb wave | | | | | |
| Second | 1604 | 1550 | 0.4 | 220 | 21 |
| lamb wave | | | | | |
| Second | 1604 | 1550 | 0.4 | 100 | 17.5 |
| lamb wave | | | | | |

In at least one example, the determining at least one phase of the material separated by the barrier at least in part by the features of the first recorded waveform data and the second recorded waveform data includes: generating a data cross plot, of the first recorded waveform data and second recorded waveform data, with a vertical axis of a feature of symmetric lamb wave and a horizontal axis of a feature of antisymmetric mode lamb wave. In at least one example, the method may include determining material properties in at least one annulus using a distribution of the data cross plot. In at least one example, the data cross plot is obtained by collecting the features of symmetric and antisymmetric mode lamb waves for same material in the at least one annulus. In at least one example, the method may determine the material in an annulus using the features, wherein determining the material includes determining if the material is gas, liquid or solid, further includes implementing a machine learning algorithm which takes barrier thickness, drilling fluid's velocity, drilling fluid's density, S0 attenuation and A0 attenuation as inputs.

The method can process the second visco-elastic waves and the attenuation of S0 mode lamb wave following same process as mentioned above.

The method may generate a data plot, of the first recorded waveform data and second recorded waveform data, with a vertical axis of symmetric zero-order mode (S₀) attenuation and a horizontal axis of zero-order antisymmetric mode (A₀) attenuation.

The method may determine a material phase. In one example, the method may determine a solid value of S₀ attenuation level above which the material in the annulus is a solid. In another example, the method can determine a liquid value, when the value of S₀ attenuation level is below the solid value, of A₀ attenuation level above which the material in the annulus is a liquid. The method can also classify material that is below the liquid value of A₀ attenuation level and below the solid value of S₀ attenuation level as gaseous material.

The method can also include determining the solid value includes implementing a machine learning algorithm. The machine learning algorithm can take the velocity of drilling fluids, density of drilling fluids, barrier thickness, A₀ attenuation, S₀ attenuation as inputs and give whether the material is solid, liquid or gas as outputs. One example of such machine learning algorithm can be XGboosting algorithm. The present disclosure can also implement other machine learning algorithms such as random forest, logistic regaression, gradient boosting, naive bayes, reinforcement random forest, and/or bootstrap sampling.

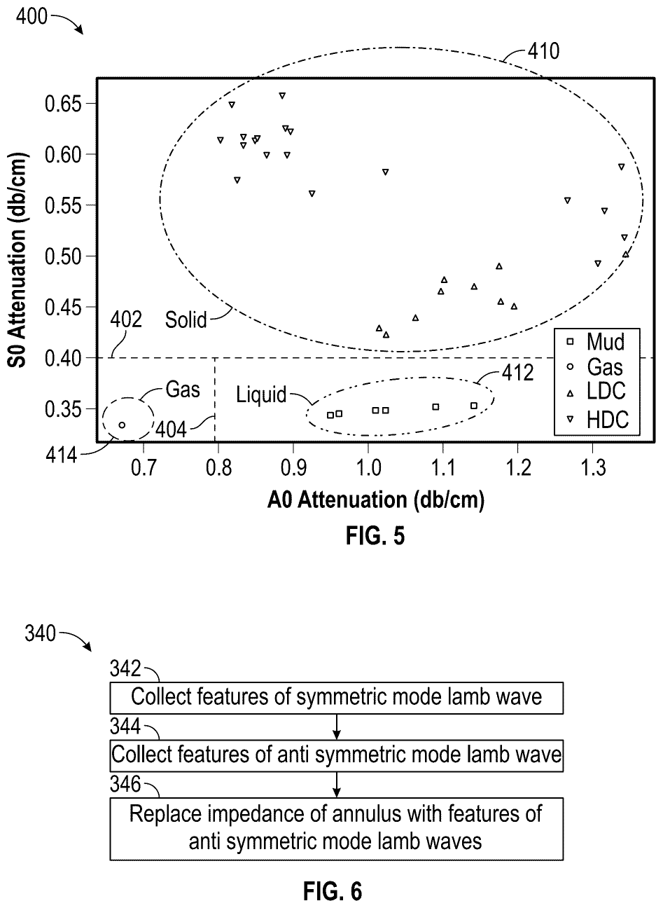

FIG. 5 illustrates a graph of a plot 400 of data in accordance with various aspects of the disclosure. FIG. 5 is a cross plot 400 of the features of symmetric lamb waves and the features of antisymmetric lamb waves. As illustrated, the data that was collected at individual data points is illustrated. It is classified into mud, gas, Low Density Cement (LDC), and High Density Cement (HDC). Additionally, the plot 400 is made with a vertical axis of S₀ attenuation and horizontal axis of A₀ attenuation. The plot is illustrated such that a solid phase line 402 can be established. The solid phase line 402 is referred to above which the material in the annulus is a solid. Additionally, a liquid phase line 404 can be established. The liquid phase line 404 is also referred to herein as a liquid value, when the value of S₀ attenuation is below the solid phase line 402, of A₀ attenuation above which the material in the annulus is a liquid. Additionally, material that is below the liquid value of A₀ attenuation and below the solid phase line 402 as gaseous material. Furthermore, a grouping of the solid data points is illustrated as being contained within region solid region 410, liquid within a liquid region 412, and gas within gas region 414.

FIG. 6 is a diagram illustrating the process 340 of creating the cross plot in FIG. 5 for a given drilling fluid, barrier thickness and barrier material. At block 342, the method collect the feature of Symmetric mode lamb wave for gas, liquid and solid annulus with different impedance which can be for example the attenuation of zero mode symmetric mode lamb wave S0.

At block 344, the method collects the feature of Antisymmetric mode lamb wave for gas, liquid and solid annulus with different impedance which can be for example the attenuation of zero mode antisymmetric mode lamb wave A₀.

At block 346, the methodology replaces the impedance of annulus in block 342 with features of antisymmetric mode lamb wave in 344 and obtains an relationship between features of symmetric and antisymmetric mode lamb waves, which can be for example the cross plot in FIG. 5. The machine learning algorithm mentioned above can be trained with the dataset obtained from process 340.

FIG. 7 is a diagram illustrating an example of a system for implementing certain aspects of the present technology in accordance with some aspects of the disclosure. In particular, FIG. 7 illustrates an example of computing system 600, which may be for example any computing device making up an internal computing system, a remote computing system, a sensor, or any component thereof in which the components of the system are in communication with each other using connection 605. Connection 605 may be a physical connection using a bus, or a direct connection into processor 610, such as in a chipset architecture. Connection 605 may also be a virtual connection, networked connection, or logical connection.

In some aspects, computing system 600 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example computing system 600 includes at least one processing unit (CPU or processor) 610 and connection 605 that couples various system components including system memory 615, such as ROM 620 and RAM 625 to processor 610. Computing system 600 may include a cache 612 of high-speed memory connected directly with, in close proximity to, or integrated as part of processor 610.

Processor 610 may include any general purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which may represent any number of input mechanisms, such as a microphone for speech, a touch-sensitive screen for gesture or graphical input, keyboard, mouse, motion input, speech, etc. Computing system 600 may also include output device 635, which may be one or more of a number of output mechanisms. In some instances, multimodal systems may enable a user to provide multiple types of input/output to communicate with computing system 600. Computing system 600 may include communications interface 640, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, lamb wave signal transfer, microwave signal transfer, infrared signal transfer, visible light signal transfer, ultraviolet light signal transfer, wireless signal transfer along the electromagnetic spectrum, or some combination thereof. The communications interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 630 may include software services, servers, services, etc., that when the code that defines such software is executed by the processor 610, it causes the system to perform a function. In some aspects, a hardware service that performs a particular function may include the software component stored in a computer-readable medium in connection with the necessary hardware components, such as processor 610, connection 605, output device 635, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the IP standard, and/or other types of data.

The components of the computing device may be implemented in circuitry. For example, the components may include and/or may be implemented using electronic circuits or other electronic hardware, which may include one or more programmable electronic circuits (e.g., microprocessors, GPUs, DSPs, CPUs, and/or other suitable electronic circuits), and/or may include and/or be implemented using computer software, firmware, or any combination thereof, to perform the various operations described herein.

In some aspects the computer-readable storage devices, mediums, and memories may include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures may include hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices, or other small form factor personal computers, personal digital assistants, rackmount devices, standalone devices, and so on. The functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more DSPs, general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. A method for determining a phase of a material in an annulus between a barrier and a formation of a well, the method comprising: deploying a logging tool having a plurality of receivers and at least one transmitter, at a first incidence angle with the barrier, to insonify at least a part of the barrier with at least one transmitter; emitting from at least one transmitter, at the first incidence angle, a first visco-elastic wave, wherein the barrier is operable to guide in part the first visco-elastic wave; recording a first waveform data received at least two of the plurality of receivers, wherein the first waveform data includes data at least in part from the barrier; emitting, from at least one transmitter at a second incidence angle to the barrier, a second visco-elastic wave, wherein the barrier is operable to guide in part the second visco-elastic wave; recording a second waveform data received at least two of the plurality of receivers, wherein the second waveform data includes data at least in part from the barrier; determining at least one phase of the material separated by the barrier at least in part by features of the first recorded waveform data and the second recorded waveform data.

Aspect 2. The method of Aspect 1 wherein the barrier comprises at least one of tubing, barrier in a single cased wellbore, and/or at least one barrier in a multi-cased wellbore.

Aspect 3. The method of any one of Aspects 1-2, wherein a mode of the first visco-elastic wave can be a combination of zero (S₀), first (S₁), and/or higher (Sₙ) order symmetric lamb wave.

Aspect 4. The method of any one of Aspects 1-3, wherein a mode of the first or second visco-elastic waves can be a combination of zero (A₀), first (A₁) or higher (Aₙ) order antisymmetric lamb waves.

Aspect 5. The method of any one of Aspects 1-4, wherein determining at least one phase of the material separated by the barrier at least in part by the features of the first recorded waveform data and the second recorded waveform data includes, generating a data cross plot, of the first recorded waveform data and second recorded waveform data, with a vertical axis of a feature of symmetric lamb wave and a horizontal axis of a feature of antisymmetric mode lamb wave; determining material properties in at least one annulus using a distribution of the data cross plot.

Aspect 6. The method of Aspect 5, wherein the data cross plot is obtained by collecting the features of symmetric and antisymmetric mode lamb waves for same material in the at least one an annulus.

Aspect 7. The method of any one of Aspects 1-6, wherein the features of the first and second visco-elastic waves can be attenuations of the waves.

Aspect 8. The method of any one of Aspects 1-7, wherein determining a S₀ attenuation level above which the material in the annulus is a solid, a A₀ attenuation level above which but below the S₀ attenuation level, the material in annulus is liquid, and below both S₀ and A₀ attenuation levels the material in annulus is gas.

Aspect 9. The method of any one of Aspects 1-8, wherein the first visco-elastic wave and the second visco-elastic wave have a same frequency.

Aspect 10. The method of any one of Aspects 1-9, wherein the first visco-elastic wave and the second visco-elastic wave have a different frequency.

Aspect 11. The method of any one of Aspects 1-10, wherein the first incidence angle of transmitter is a negative angle of a first incidence angle of the receivers.

Aspect 12. The method of any one of Aspects 1-11, wherein the second incidence angle of transmitter is a negative angle of a second incidence angle of the receivers.

Aspect 13. The method of any one of Aspects 1-12, further comprising adjusting the first incidence angle based upon a fluid within the barrier, barrier material, and barrier thickness.

Aspect 14. The method of Aspect 13, wherein the adjusting the first incidence angle provides that A₀ lamb wave travels in parallel to the barrier.

Aspect 15. The method of any one of Aspects 1-14 further comprising adjusting the second incidence angle based upon a fluid within the barrier, barrier material, and barrier thickness.

Aspect 16. The method of Aspect 15, wherein the adjusting the second incidence angle provides that S₀ lamb wave travels in parallel to the barrier.

Aspect 17. The method of any one of Aspects 1-16, wherein the plurality of receivers are four or more.

Aspect 18. The method of any one of Aspects 1-17, further comprising adjusting the first incidence angle as a diameter of the barrier changes.

Aspect 19. The method of any one of Aspects 1-18, further comprising adjusting the first incidence angle as a thickness of the barrier changes.

Aspect 20. The method of any one of Aspects 1-19, further comprising adjusting the first incidence angle as a fluid within the barrier changes.

Aspect 21. The method of any one of Aspects 1-20, further comprising adjusting the second incidence angle as a diameter of the barrier changes.

Aspect 22. The method of any one of Aspects 1-21, further comprising adjusting the second incidence angle as a thickness of the barrier changes.

Aspect 23. The method of any one of Aspects 1-22, further comprising adjusting the second incidence angle as a fluid within the barrier changes.

Aspect 24. The method of any one of Aspects 1-23, further comprising determining the material in an annulus using the features, wherein determining the material includes implementing a XGboosting machine learning algorithm.

Aspect 25. The method of any one of Aspects 1-24, further comprising determining the material in an annulus using the features, wherein determining the material includes determining if the material is gas, liquid or solid, further includes implementing a machine learning algorithm which takes barrier thickness, drilling fluid's velocity, drilling fluid's density, S0 attenuation and A0 attenuation as inputs.

Aspect 26. A system for determining a phase of a material in an annulus between a barrier and a formation of a well, the system comprising: a logging tool having a plurality of receivers and at least one transmitter configured such that a barrier may be insonified at at least one first and one second angle of incidence with at least one visco-elastic wave; at least two receivers configured to receive energy related to a waveform of the insonified barrier, the tool also having at least one processor operable to: cause the transmitter to emit, from the transmitter at the first incidence angle first visco-elastic waves; record first waveform data received at least two of the plurality of receivers resulting from the first angle insonified barrier; emit, from at least one transmitter at a second incidence angle to the barrier, second visco-elastic waves; record second waveform data received at at least two of the plurality of receivers resulting from the second angle insonified barrier; an information handling system configured to: receive the first waveform data and the second waveform data; process features of the first recorded waveform data and the second recorded waveform data; determine at least one phase of the material in at least one annulus using the features.

Aspect 27. A tool for determining a phase of a material in at least one annulus between at least one barrier and a formation of a well, the tool comprising: at least one processor; at least one memory coupled to the at least one processor and operable to store instructions; a plurality of receivers coupled to the at least one processor; a plurality of transmitters coupled to the at least one processor and configurable to form a first and a second incidence angle with the barrier; the transmitters operable to emit, at the first incidence angle, first visco-elastic waves; the transmitters configurable, to a second incidence angle that is different from the first incidence angle and emit, at the second incidence angle, second visco-elastic waves; the plurality of receivers configurable to record first waveform data received at at least two of the plurality of receivers resulting from a first angle insonified barrier and to record second waveform data received at least two of the plurality of receivers resulting from a second angle insonified barrier; the at least one memory operable to store instruction to cause the at least one processor to: process features of the first recorded waveform data and the second recorded waveform data; determine at least one phase of the material in at least one annulus using the features.

What is claimed is:

1. A method for determining a phase of a material in an annulus between a barrier and a formation of a well, the method comprising:
deploying a logging tool having a plurality of receivers and at least one transmitter, at a first incidence angle with the barrier, to insonify at least a part of the barrier with at least one transmitter;
emitting from at least one transmitter, at the first incidence angle, a first visco-elastic wave, wherein the barrier is operable to guide in part the first visco-elastic wave;
recording a first waveform data received at least two of the plurality of receivers, wherein the first waveform data includes data at least in part from the barrier;
emitting, from at least one transmitter at a second incidence angle to the barrier, a second visco-elastic wave, wherein the barrier is operable to guide in part the second visco-elastic wave;
recording a second waveform data received at least two of the plurality of receivers, wherein the second waveform data includes data at least in part from the barrier;
determining at least one phase of the material separated by the barrier at least in part by features of the first recorded waveform data and the second recorded waveform data.

2. The method of claim 1 wherein the barrier comprises at least one of tubing, barrier in a single cased wellbore, and/or at least one barrier in a multi-cased wellbore.

3. The method of claim 1, wherein a mode of the first visco-elastic wave can be a combination of zero (S₀), first (S₁), and/or higher (Sₙ) order symmetric lamb wave.

4. The method of claim 1, wherein a mode of the first or second visco-elastic waves can be a combination of zero (A₀), first (A₁) or higher (Aₙ) order antisymmetric lamb waves.

5. The method of claim 1, wherein determining at least one phase of the material separated by the barrier at least in part by the features of the first recorded waveform data and the second recorded waveform data includes,
generating a data cross plot, of the first recorded waveform data and second recorded waveform data, with a vertical axis of a feature of symmetric lamb wave and a horizontal axis of a feature of antisymmetric mode lamb wave;
determining material properties in at least one annulus using a distribution of the data cross plot.

6. The method of claim 5, wherein the data cross plot is obtained by collecting the features of symmetric and antisymmetric mode lamb waves for same material in the at least one an annulus.

7. The method of claim 1, wherein the features of the first and second visco-elastic waves can be attenuations of the waves.

8. The method of claim 1, wherein determining a S₀ attenuation level above which the material in the annulus is a solid, a A₀ attenuation level above which but below the S₀ attenuation level, the material in annulus is liquid, and below both S₀ and A₀ attenuation levels the material in annulus is gas.

9. The method of claim 1, wherein the first visco-elastic wave and the second visco-elastic wave have a same frequency.

10. The method of claim 1, wherein the first visco-elastic wave and the second visco-elastic wave have a different frequency.

11. The method of claim 1, wherein the first incidence angle of transmitter is a negative angle of a first incidence angle of the receivers.

12. The method of claim 1, wherein the second incidence angle of transmitter is a negative angle of a second incidence angle of the receivers.

13. The method of claim 1, further comprising adjusting the first incidence angle based upon a fluid within the barrier, barrier material, and barrier thickness.

14. The method of claim 13, wherein the adjusting the first incidence angle provides that A₀ lamb wave travels in parallel to the barrier.

15. The method of claim 1, further comprising adjusting the second incidence angle based upon a fluid within the barrier, barrier material, and barrier thickness.

16. The method of claim 15, wherein the adjusting the second incidence angle provides that S₀ lamb wave travels in parallel to the barrier.

17. The method of claim 1, wherein the plurality of receivers are four or more.

18. The method of claim 1, further comprising adjusting the first incidence angle as a diameter of the barrier changes.

19. A system for determining a phase of a material in an annulus between a barrier and a formation of a well, the system comprising:
a logging tool having a plurality of receivers and at least one transmitter configured such that a barrier may be insonified at at least one first and one second angle of incidence with at least one visco-elastic wave;
at least two receivers configured to receive energy related to a waveform of the insonified barrier, the tool also having at least one processor operable to:
cause the transmitter to emit, from the transmitter at the first incidence angle first visco-elastic waves;
record first waveform data received at at least two of the plurality of receivers resulting from the first angle insonified barrier;
emit, from at least one transmitter at a second incidence angle to the barrier, second visco-elastic waves;
record second waveform data received at at least two of the plurality of receivers resulting from the second angle insonified barrier;
an information handling system configured to:
receive the first waveform data and the second waveform data;
process features of the first recorded waveform data and the second recorded waveform data;
determine at least one phase of the material in at least one annulus using the features.

20. A tool for determining a phase of a material in at least one annulus between at least one barrier and a formation of a well, the tool comprising:
at least one processor;
at least one memory coupled to the at least one processor and operable to store instructions;
a plurality of receivers coupled to the at least one processor;
a plurality of transmitters coupled to the at least one processor and configurable to form a first and a second incidence angle with the barrier;
the transmitters operable to emit, at the first incidence angle, first visco-elastic waves;
the transmitters configurable, to a second incidence angle that is different from the first incidence angle and emit, at the second incidence angle, second visco-elastic waves;
the plurality of receivers configurable to record first waveform data received at at least two of the plurality of receivers resulting from a first angle insonified barrier and to record second waveform data received at least two of the plurality of receivers resulting from a second angle insonified barrier;
the at least one memory operable to store instruction to cause the at least one processor to:
process features of the first recorded waveform data and the second recorded waveform data;
determine at least one phase of the material in at least one annulus using the features.
